(19) United States
(12) Patent Application Publication
(10) Pub. No.: US 2021/0045407 A1
(43) Pub. Date: Feb. 18, 2021

(54) CANDY FIGURE WITH INTERCHANGEABLE ELEMENTS

(71) Applicant: Ferrara Candy Company, Chicago, IL (US)

(72) Inventor: Judy Jonhee Lee, Highwood, IL (US)

(21) Appl. No.: 16/992,995

(22) Filed: Aug. 13, 2020

Related U.S. Application Data
(60) Provisional application No. 62/886,107, filed on Aug. 13, 2019.

(51) Int. Cl. A23G 3/54; A23G 3/34

(52) U.S. Cl. CPC A23G 3/54; A23V 2002/00; A23G 3/343

(57) ABSTRACT

A system and method are disclosed for forming a novelty candy assembly such as edible confection figures. The system includes interchangeable edible first confection elements of different colors or shapes. Interchangeable edible second confection elements may have different colors or shapes. Each of the second confection elements may be interchangeably mountable to each of the first confection elements. The system may include interchangeable edible third confection elements of different colors or shapes. Each of the third confection elements may be interchangeably mountable to one of each of the first or second confection elements.

### CROSS REFERENCE TO RELATED APPLICATIONS

This application claims the benefit of U.S. Provisional Application No. 62/886,107, filed Aug. 13, 2019. The entirety of the above referenced application is hereby incorporated by reference.

### TECHNICAL FIELD

The present disclosure is directed to novelty candies and in particular to a system for forming edible candy assemblies from interchangeable complementary confection components.

### BACKGROUND

Novelty candies provide consumers with entertainment and a treat. Novelty candies may come with prizes, have packaging that may be played with or otherwise provide entertainment. Some novelty candies have shapes or patterns that provide interaction and amusement for the consumer.

Gelled “gummy” confectionery products are widely known chewy candy with a springy, resilient character with varying degrees of firmness. These confectionery products are often made with gelatin or gelatin alternatives, corn syrup and/or sugar and starches. Such candies may include a “sour sanding” coating to achieve both a sweet and tart taste sensation.

Systems of interactive candy with different pieces being combined are known. U.S. Published Patent Application 2008/0171111 shows an Assembly of Solid Confectionary Pieces. Confectionary pieces are formed with a recess, through hole or cut out and are made to be played with without touching them by hand.

Systems of connectable gummy type candies have been developed using interlocking gummy blocks. HILCO Corporation of King of Prussia, Pa., produces “Gummy Blocks” novelty candies. The candies are configured as rectangular brick-type building blocks with studs and complementary recesses that may be joined together to create various structures. The bricks have different colors and flavors. See “4D Gummy Blocks” Web page <http://www.hilcousa.com/>, 1 page, Apr. 29, 2019, retrieved from Internet Archive Wayback Machine <https://web.archive.org/web/20190429023848/http://www.hilcousa.com/> on Aug. 12, 2020.

Other gummy type candies having different combinable pieces have been developed such as “Airheads Gummies” produced by Perfetti Van Melle (http://perfettivanmelleus.com/2019/10/27/airheads-gummies/) and “Match-Ems” gummies produced by The Topps Co., Inc (“Candymania: Match-Ems” Web page <https://www.candymania.com/category/match-ems/>, 1 page, Jul. 21, 2019, retrieved from Internet Archive Wayback Machine <https://web.archive.org/web/20190721160915/https://www.candymania.com/categor y/match-ems/> on Aug. 13, 2020).

Trolli® candies include sweet and sour gummi candies in various shapes including various animals, hands, stars, and other shapes. Trolli® gummi candies are configured as monolithic elements. In some candies, two or more portions of a Trolli® gummi candies may have a different color and/or flavor. In some aspects, at least one portion of a Trolli® gummi candy piece may have a first color and a first flavor, while at least a second portion may have a second color and a second flavor.

Although some of these confections provide a degree of interaction and others provide for flavor combinations, further improvements in interaction and flavor combinations are possible. A need exists for interaction with candies formed into figures, dolls, creatures, multi-component foods, or other assemblies. Such a system should provide for creating figures having assemblies of different combinations of components. The various components of the figures should be interchangeable to create a wide variety of permutations. Moreover, the components should be available in a variety of different colors and/or flavors to achieve further permutations in appearance and different flavor combinations. The present disclosure addresses these as well as other challenges related to interactive confections.

### BRIEF SUMMARY

The present disclosure is directed to a system of interchangeable confection elements or components that are connectable to form edible novelty candy assemblies of different configurations, shapes and/or flavors. These edible assemblies may make novelty candies that generally resemble figures, including, but not limited to, robots, aliens, monsters, cartoon characters, creatures, geometric forms (such as lines, triangles, or spheres) bodily shapes, objects noticeable only as shape or form, persons, things, animals, and foods, that are made with different types of ingredients or other assembled confections. The figures may have a theme such as robots, aliens, monsters, cartoon characters, etc. An edible assembly may contain at least a first interchangeable element and at least a second interchangeable element where the second interchangeable element is interchangeably mountable to the first interchangeable element.

The system is generally made of “gummy” type elements. The composition may be similar to the composition of Trolli® candies, but other compositions such as in fruit snacks or Black Forest® gummies are also foreseen. The different components of the system may be fruit-flavored elements. Each different color may have an associated flavor. Therefore, different flavor combinations may be achieved by mixing and matching different colored components. Consumers may selectively create desired taste combinations. For example, green candy elements may be lime or sour apple, red elements may be cherry or strawberry, blue elements may be raspberry, orange elements may be orange, purple elements may be grape, yellow elements may be lemon, etc. The multiple flavors allow for mixing and matching achieving a large number of different permutations of flavor combinations. In some embodiments, one or more elements are gummies. In other embodiments, two or more elements are gummies; in further embodiments, three or more elements are gummies.

The confection elements may be coated with “sour sanding” to provide sweet and tart taste enhancements to the consumer, or the confection may be an “oiled” type gummy. Oiled gummies are created by applying an oil or other polishing agent layer to the outside of the gummy in the final stages of processing. This gives a shiny appearance to the outside of the gummy and is used to prevent sticking between pieces. The oiling process may be automated in an oiling drum. Sanded gummies can be sweet or sour; many sanded gummies use “sour sanding” which is a mixture of sugar plus a tart/sour agent such as tartaric or citric acid. These are created by applying steam to a finished gummy to add tackiness, then adding the sanding coating. The sanding process may also be automated. Sanding adds to the gummy flavor profile and is also used to prevent sticking between pieces. In one embodiment, at least one of the confection elements comprises a sour sanding coating.

These assemblies may make novelty candies that have a general 2-dimensional (2D) or 3-dimensional (3D) shape, such as figures. As discussed above, figures may have a theme such as robots, aliens, monsters, cartoon characters, etc. In one aspect, the assemblies are made of one type of interchangeable component, alternatively at least two types of interchangeable components, alternatively at least three types of interchangeable components, alternatively at least four types of interchangeable components. In some aspects, interchangeable component is described as an interchangeable element. The components are interchangeably mixed and matched to create different figures when assembled. The assemblies may be figures in one embodiment, but other assemblies of multiple candy elements are also foreseen, such as multi-component foods and other assembled candy constructions.

In one aspect, a first type of interchangeable component (first interchangeable element) may be configured as a body element. Each style of the first interchangeable element may have at least one color. Each color may have an associated flavor. In some aspects, there are multiple different colors for each style of the first interchangeable element. In some aspects, each color may represent a different flavor. In some aspects, the first interchangeable element may be generally configured as rounded, alternatively rounded bodies. In other aspects, the first interchangeable element may be generally configured as squared-off, alternatively squared-off bodies having a more angular structure. The first interchangeable element further includes a widened base and exterior side surfaces. A widened base allows a 3D figure to be assembled upright. The widened base may have a top wall, bottom wall, and sidewalls. In some aspects, the top wall has an opening leading to a receiving channel that receives at least a portion of a second interchangeable element, wherein the portion has been adapted to mount in or on to the first interchangeable element. In some aspects, the receiving channel may be a female channel. The female channel may be tapered to ease insertion of the portion of the second interchangeable element and facilitate assembly. The first interchangeable element (body) may include ornamentation, including, but not limited to, dots, stripes, lines or chevrons, which may be raised and/or in relief.

In one aspect, a second type of interchangeable component (second interchangeable element) may be configured as head element, wherein the head element includes a portion that has been adapted to mount in or on to the first interchangeable element. In some aspects, this portion may be a peg-like connector (male connector). The male connector may be sized and configured to extend into and to be received by the female channel of first interchangeable element. The male connector may be tapered to ease insertion and assembly. In some aspects, both the male connector on the second interchangeable element and the female receiving channel on the first interchangeable element may have a complementary taper to ease insertion and assembly.

In some aspects, the mounting of the second interchangeable element in or on to the first interchangeable element creates a figure. Each style of the second interchangeable element may have at least one color. In some aspects, there are multiple different colors for each style of the second interchangeable element. In some aspects, each color may represent a different flavor. The second interchangeable element may include ornamentation, including but not limited to, eyes, ears and/or a face. In one aspect, the second interchangeable element is generally configured as alien type heads with eyes, ears and/or faces. The first interchangeable and second interchangeable elements may be interchangeably connected to form figures, but may also receive a further element as explained hereinafter. The multiple different colors and flavors of the first interchangeable and second interchangeable elements may be mixed and matched to form multiple distinct permutations of shape and color combinations. The same color combinations also form multiple different flavor combinations. Figures may include, but are not limited to, aliens, monsters, cartoon characters, creatures, geometric forms, bodily shapes, objects, persons, things, animals, and foods.

In one aspect, a third type of component (third interchangeable element) may be configured as different accessory elements (“accessories”) that may be assembled along with the first and second interchangeable elements. Each of the third interchangeable elements includes an opening, which may be in the center. When the novelty candy assembly is a figure, the third interchangeable element (accessory) may be configured as hats, helmets, rings, vehicles, etc. In some aspects, the third interchangeable element may be configured as a ring type accessory, which may be round, square or have another shape. In some aspects, the opening is a through-hole that extends completely or partially through the third interchangeable element. Outer edges of the third interchangeable element may create different shaped profiles and/or cross-sections with different shapes and peripheries. At least one face of the third interchangeable element may include ornamentation, such as dots, stripes, lines or chevrons, which may be raised and/or in relief. Each of the third interchangeable element may have multiple different colors, which may each represent a different flavor.

In some aspects, the third interchangeable element may be configured as ring type accessory that mounts on a combined first and second interchangeable element assembly. The ring type accessory may have a center opening that is a through-hole extending completely through the third interchangeable element. In some aspects, the ring type third interchangeable element may have outer edges creating different shaped profiles and/or cross-sections with different shapes and peripheries. The third interchangeable element may be configured to mount interchangeably with the peg-like male connector portion and/or a portion of the body extending through the center opening of the ring.

When assembled, the first, second, and third interchangeable elements form figure-type systems and create novelty candies that are edible assemblies. The multiple different colors and flavors of the first, second, and third interchangeable elements may be mixed and matched to form multiple distinct permutations of shape and color combinations. The same color combinations also form multiple different flavor combinations.

These features are pointed out with particularity in the claims annexed hereto and forming a part hereof. These and other advantages, aspects, and novel features of the present disclosure, as well as details of an illustrated embodiment thereof, will be more fully understood from the following description and drawings.

### BRIEF DESCRIPTION OF THE DRAWINGS

The patent or application file contains at least one drawing executed in color. Copies of this patent or patent application publication with color drawings will be provided by the Office upon request and payment of the necessary fee.

Referring now to the drawings wherein like reference numerals and letters indicate corresponding structure throughout the several views:

FIG. 1 is a top plan view of a system of interchangeable elements for forming edible assemblies according to the principles of the present disclosure;

FIGS. 2A-2C are views of a first embodiment of a first interchangeable element for the edible assembly shown in FIG. 1. FIG. 2A is a perspective view of a first embodiment of a first interchangeable element. FIG. 2B is a top plan view of the first embodiment of the first interchangeable element. FIG. 2C is a computer-generated rendering of the first embodiment of the first interchangeable element.

FIGS. 3A-3C are views of a second embodiment of the first interchangeable element shown in FIG. 1. FIG. 3A is a perspective view of a second embodiment of a first interchangeable element. FIG. 3B is a top plan view of the second embodiment of the first interchangeable element. FIG. 3C is a computer-generated rendering of the second embodiment of the first interchangeable element.

FIGS. 4A-4C are views of a first embodiment of a second interchangeable element for the edible assembly shown in FIG. 1. FIG. 4A is a perspective view of a first embodiment of a second interchangeable element. FIG. 4B is a top plan view of the first embodiment of the second interchangeable element. FIG. 4C is a computer-generated rendering of the first embodiment of the second interchangeable element.

FIGS. 5A-5C are views of a second embodiment of a second interchangeable element for the edible assembly shown in FIG. 1. FIG. 5A is a perspective view of a second embodiment of a second interchangeable element. FIG. 5B is a top plan view of the second embodiment of the second interchangeable element. FIG. 5C is a computer-generated rendering of the second embodiment of the second interchangeable element.

FIGS. 6A-6C are views of a third embodiment of a second interchangeable element for the edible assembly shown in FIG. 1. FIG. 6A is a perspective view of a third embodiment of a second interchangeable element. FIG. 6B is a top plan view of the third embodiment of the second interchangeable element. FIG. 6C is a computer-generated rendering of the third embodiment of the second interchangeable element.

FIGS. 7A-7C are views of a fourth embodiment of a second interchangeable element for the edible assembly shown in FIG. 1. FIG. 7A is a perspective view of a fourth embodiment of a second interchangeable element. FIG. 7B is a top plan view of the fourth embodiment of the second interchangeable element. FIG. 7C is a computer-generated rendering of the fourth embodiment of the second interchangeable element.

FIGS. 8A-8C are views of a first embodiment of a third interchangeable element for the edible assembly shown in FIG. 1. FIG. 8A is a perspective view of a first embodiment of a third interchangeable element. FIG. 8B is a top plan view of the first embodiment of the third interchangeable element. FIG. 8C is a computer-generated rendering of the first embodiment of the third interchangeable element.

FIGS. 9A-9C are views of a second embodiment of a third interchangeable element for the edible assembly shown in FIG. 1. FIG. 9A is a perspective view of a second embodiment of a third interchangeable element. FIG. 9B is a top plan view of the second embodiment of the third interchangeable element. FIG. 9C is a computer-generated rendering of the second embodiment of the third interchangeable element.

FIGS. 10A-10B show a first exemplary embodiment of an edible assembly. FIG. 10A is a perspective view of a first embodiment of an edible assembly in accordance with an example embodiment of the disclosure. FIG. 10B is an exploded perspective view of the first embodiment of an edible assembly shown in FIG. 10A.

FIGS. 11A-11B show a second exemplary embodiment of an edible assembly. FIG. 11A is a perspective view of a first embodiment of an edible assembly in accordance with an example embodiment of the disclosure. FIG. 11B is an exploded perspective view of the first embodiment of an edible assembly shown in FIG. 11A.

FIG. 12 is a perspective view of a third embodiment of an edible assembly in accordance with an example embodiment of the disclosure;

FIG. 13 is a perspective view of a fourth embodiment of an edible assembly in accordance with an example embodiment of the disclosure;

FIG. 14 is a perspective view of a fifth embodiment of an edible assembly in accordance with an example embodiment of the disclosure;

FIG. 15 is an exploded perspective view of a sixth embodiment of an edible assembly in accordance with an example embodiment of the disclosure;

FIG. 16 is an exploded perspective view of a seventh embodiment of an edible assembly in accordance with an example embodiment of the disclosure; and

FIG. 17 is an exploded perspective view of an eighth embodiment of an edible assembly in accordance with an example embodiment of the disclosure.

FIGS. 18A-18C show three different computer-generated renderings of the exemplary embodiment of an edible assembly in accordance with an example embodiment of the disclosure, as shown in FIG. 12. FIG. 18A is a front view. FIG. 18B is a perspective view. FIG. 18C is a side view.

### DETAILED DESCRIPTION

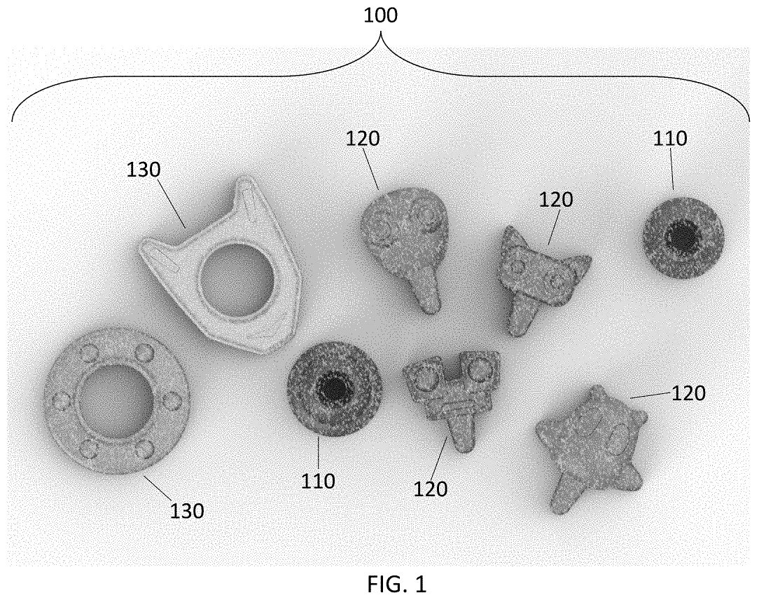

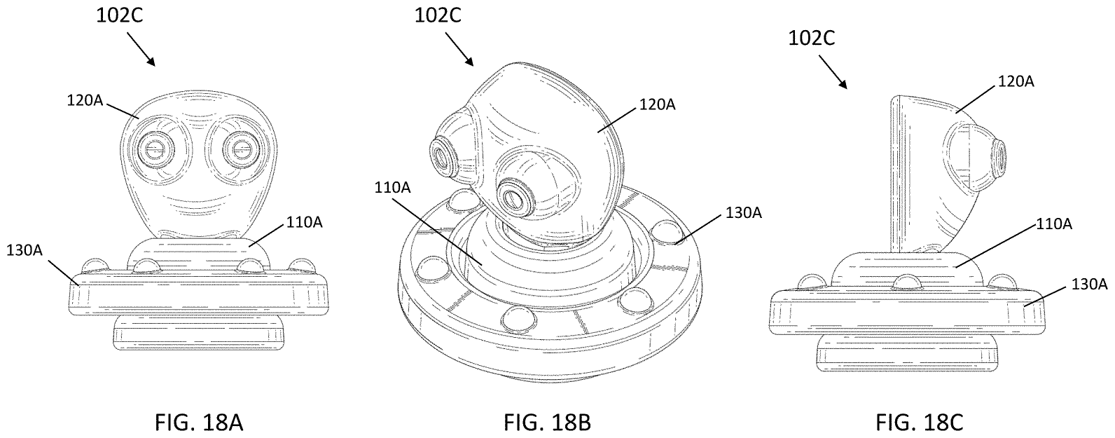

Referring now to FIG. 1, there is shown a system, generally designated 100, of interchangeable confection elements or components 110, 120, 130 that are connectable to form assemblies 102, shown in FIGS. 18-27, of different configurations, shapes and/or flavors. Such assemblies 102 may form novelty candies that generally resemble figures, including, but not limited to, robots, aliens, monsters, cartoon characters, creatures, geometric forms (such as lines, triangles, or spheres) bodily shapes, objects noticeable only as shape or form, persons, things, animals, and foods, that are made with different types of ingredients or other assembled confections. The figures may have a theme such as robots, aliens, monsters, cartoon characters, etc. In the aspects shown for the system 100, the figures 102 and components have a robot/alien theme, but other themes are also known and may be easily adopted.

In one embodiment, the system 100 is generally made of “gummy” type elements having a composition similar to the confection of Trolli® candies. The different components of the system 100 are generally fruit flavored elements, although other flavors such as mint or novelty flavors are also foreseen. Each different color may have an associated flavor. Therefore, different flavor combinations may be achieved by mixing and matching different colored components. Consumers may selectively create their desired taste combinations. For example, green candy elements may be lime or sour apple, red elements may be cherry or strawberry, orange elements may be orange, blue elements may be raspberry, purple elements may be grape, yellow elements may be lemon, etc. The multiple flavors allow for mixing and matching to achieve a large number of different permutations of flavor combinations. The confection elements 110, 120, 130 of the system 100 may be coated with “sour sanding” to provide sweet and tart taste enhancements to the consumer.

In an embodiment shown, the assemblies 102 are made of three types of interchangeable elements 110, 120, 130. It can be appreciated that the assemblies 102 may also be formed of only two interchangeable elements, only three interchangeable elements, or four or more interchangeable elements. The different components of the system 100 (such as interchangeable elements 110, 120, 130) may mixed and matched to form assemblies 102 which create different figures when assembled.

The assemblies 102 may be assembled in any order. In some aspects, two interchangeable elements may be mounted together to create a two part assembly. In other aspects, a third interchangeable element may be connected to the two-part assembly to create a three-part assembly. In certain aspects, connecting the third element occurs before, during or after mounting the first element to the second element. In other aspects, interchangeable elements may be assembled simultaneously.

Interchangeable elements 110, 120, 130 may have different sizes and be of different weights. In some embodiments, the weights of the individual interchangeable elements may be from about 2-5 grams. Thus the assemblies 102 when assembled of three parts may have combined weights of 6-15 grams.

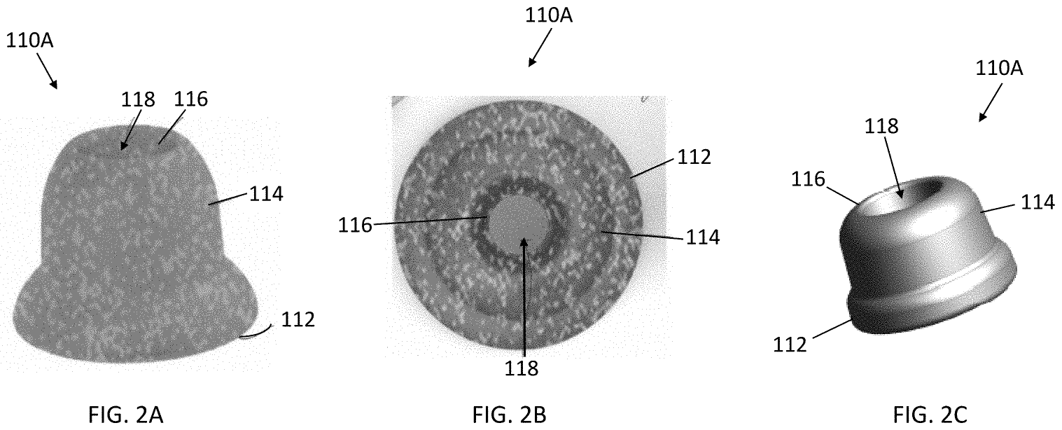

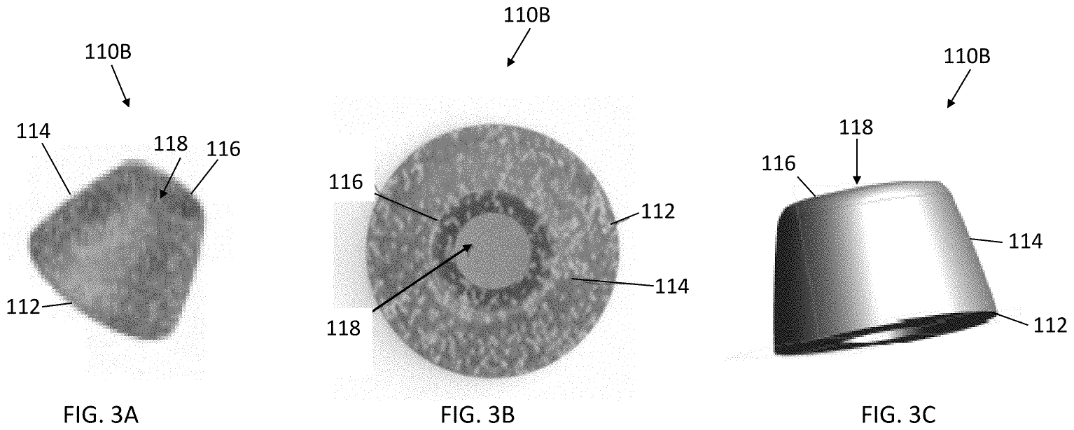

A first type interchangeable element is a body element 110. Referring to FIGS. 2 and 3, there are two body elements shown 110A and 110B. Although two different styles of body elements 110A and 110B are shown, it can be appreciated that the system 100 may also include three or more interchangeable body elements 110. Each of the body elements 110A and 110B may have multiple different colors, which may each represent a different flavor. In one embodiment, the first elements 110A and 110B are generally configured as rounded bodies, although other shapes are contemplated. Each of the bodies includes a widened base 112 and exterior side surfaces 114. The end opposite the base 112 has an opening 116 leading to a receiving channel 118. The channel 118 is configured to receive a complementary portion of second components, as explained hereinafter. Body element 110B, as with all of the different components 110, 120, and 130, may be any of the different colors. In some embodiments, different colors correspond to different flavors. Each of the elements may also be coated with sour sanding.

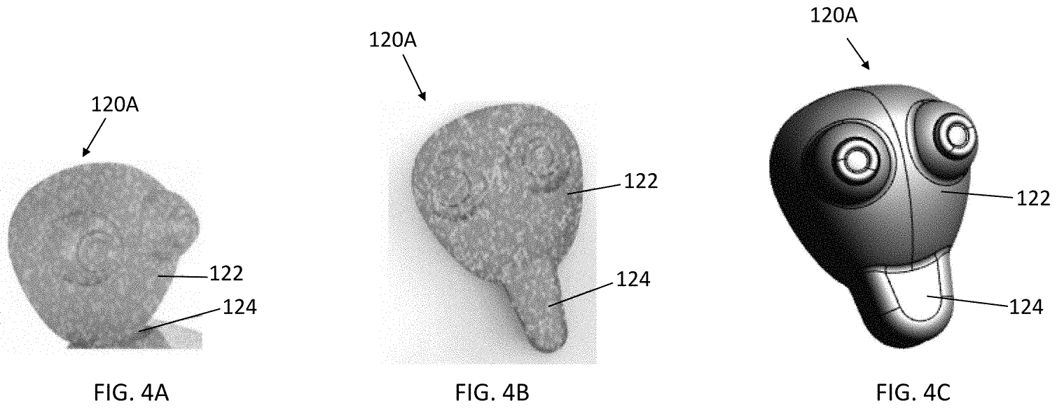

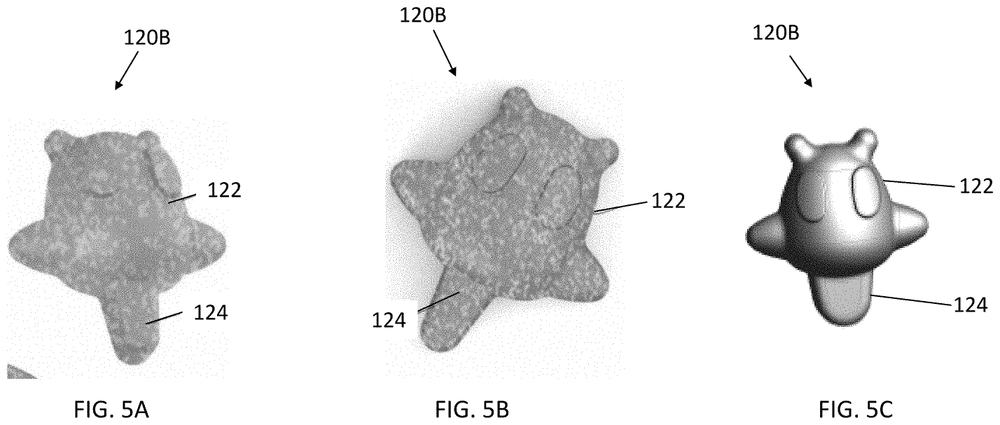

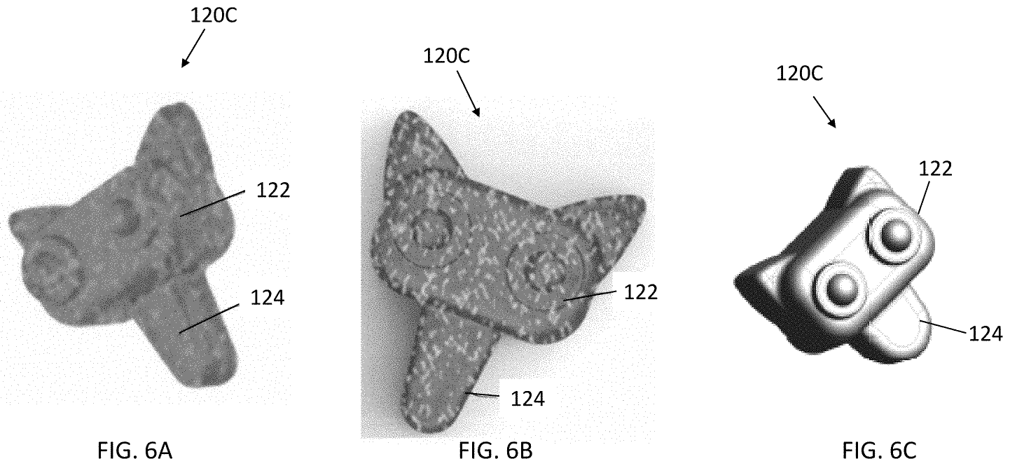

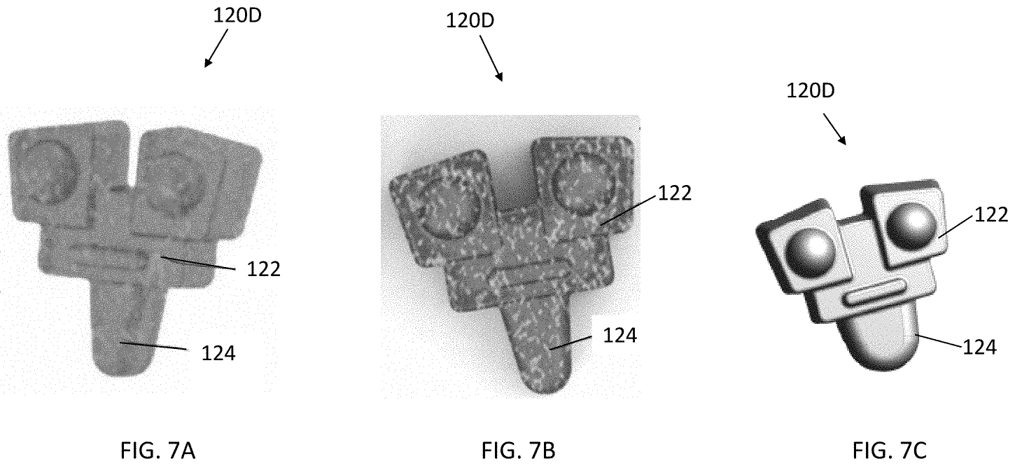

In an embodiment shown, the second type of interchangeable elements 120 are configured as heads adapted to mount to the bodies 110 to create a two-part figure. Referring to FIGS. 4-7, there are shown four head elements 120A, 120B, 120C, and 120D. Although four different styles of head elements 120A, 120B, 120C, and 120D are shown, it can be appreciated that the system 100 may also include fewer or more styles interchangeable head elements 120. Each of the head elements 120A, 120B, 120C, and 120D may have multiple different colors, which may each represent a different flavor. In one embodiment, the second elements 120A, 120B, 120C and 120D are generally configured with ornamentation to create alien type heads with eyes, ears and/or faces 122. Each of the heads includes a peg-like male connector portion 124. The male connector portion 124 is sized and configured to extend into and to be received in the complementary female channel 118 of the body elements 110. The male connector portion 124 and the complementary female receiving channel 118 may have a complementary taper to ease insertion and assembly. The heads 120 and bodies 110 may be interchangeably connected to form two part edible confection figures assemblies, but may also receive a further element as explained hereinafter. The multiple different colors and flavors of the bodies 110 and the heads 120 may be mixed and matched to form multiple distinct permutations of shape and color combinations. The same color combinations also form multiple different flavor combinations.

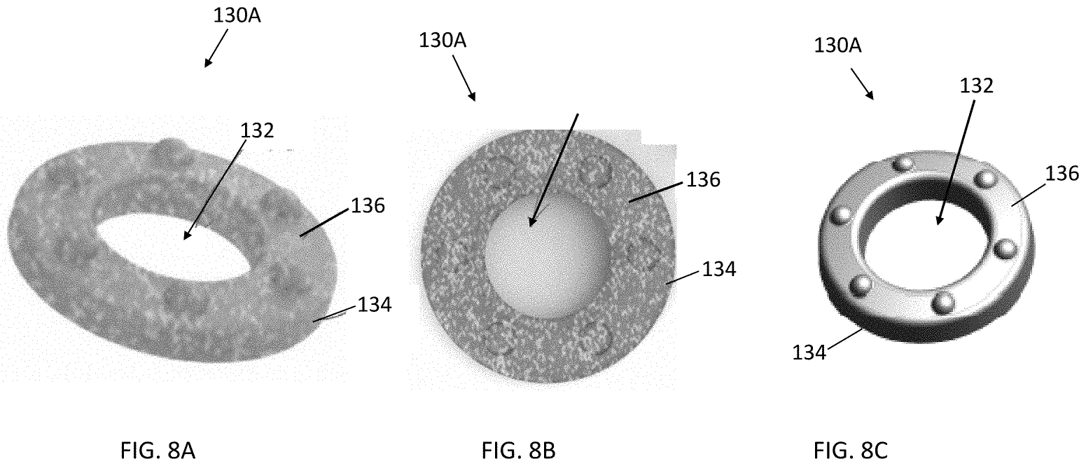

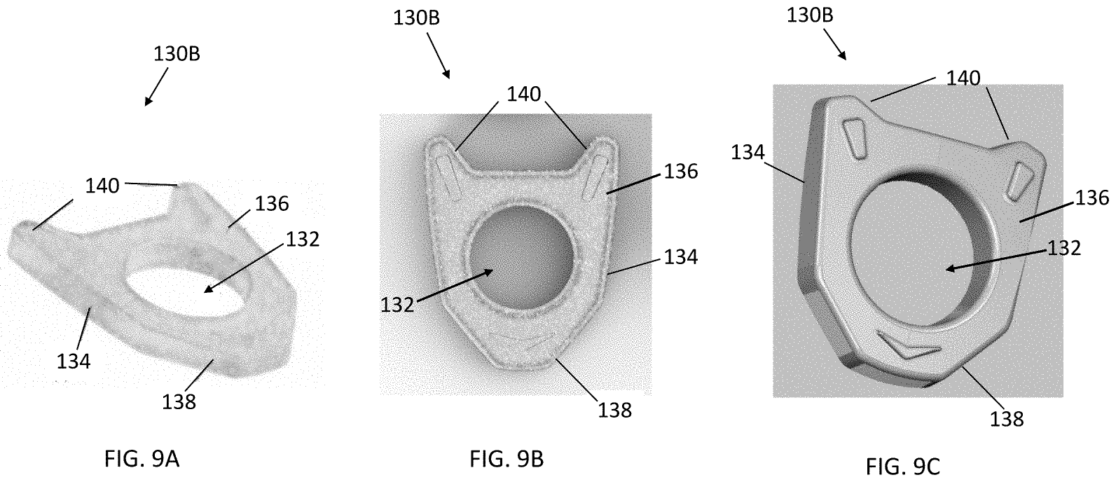

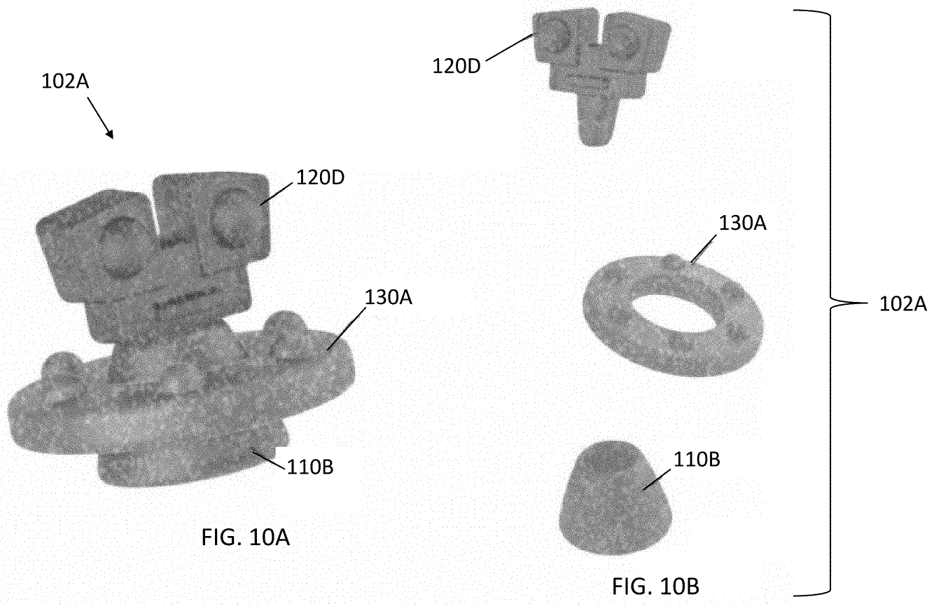

In an embodiment shown, third interchangeable elements 130 are configured as ring-type accessories that may be combined with the first and/or second interchangeable element. In one embodiment, the third interchangeable elements 130 may be combined with a head and body. Referring to FIGS. 8 and 9, there are shown ring-type elements 130A and 130B having different shapes and peripheries. The third elements 130 are configured as different accessories. Although two different styles of ring-type accessory elements 130A and 130B are shown, it can be appreciated that the system 100 may also include three or more interchangeable accessory elements 130. Each of the accessory elements 130A and 130B may have multiple different colors, which may each represent a different flavor. In one aspect, the third elements 130A and 130B are generally configured as ring-type elements. Each of the third elements includes a center opening 132. Outer edges 134 of different elements 130 may have different shaped cross-sections. Third interchangeable element 130A is shaped as a generally uniform torus while third interchangeable element 130B has a tapered portion 138 and an opposite side with projections 140. Other shapes and peripheries are also contemplated. At least one face 136 of the third interchangeable elements 130 may include ornamentation, such as dots, stripes, lines or chevrons, which may be raised/in relief. The third elements 130 are configured to mount interchangeably with the peg like connector 124 and/or a tapered portion 114 of the body 110 extending through the center opening 132 and with the accessory 130 resting on the tapered sides 114 of the body elements 110. The bodies 110, heads 120, and accessories 130 may be assembled in any order. In some aspects, the accessory 130 is placed between the body 110 and head 120 during assembly; see FIG. 10A and 10B.

When assembled, the bodies 110, heads 120, and accessories 130 form three part figure-type assemblies 102, such as shown in FIGS. 10-18. The multiple different colors and flavors of the bodies 110, heads 120, and accessories 130 may be interchangeably mixed and matched to form multiple distinct permutations of shape and color combinations. The same color combinations also form multiple different flavor combinations. The bodies 110, heads 120, and accessories 130 may be assembled in any order.

Referring now to FIGS. 10-18, there are shown particular example embodiment 102A-102H of the general figure assemblies 102. Each of the different embodiment shown has a distinct combination of a body element 110, head element 120 and accessory element 130. The embodiments shown are only examples and further combinations are also possible with the various shapes, and colors of the elements 110, 120, and 130.

Referring to FIGS. 10A and 10B, a first embodiment of a figure assembly 102A with a particular combination of elements 110, 120 and 130 is shown. The figure assembly 102A is formed from a red second body element 110B, a blue fourth head element 120D, and a green first accessory element 130A.

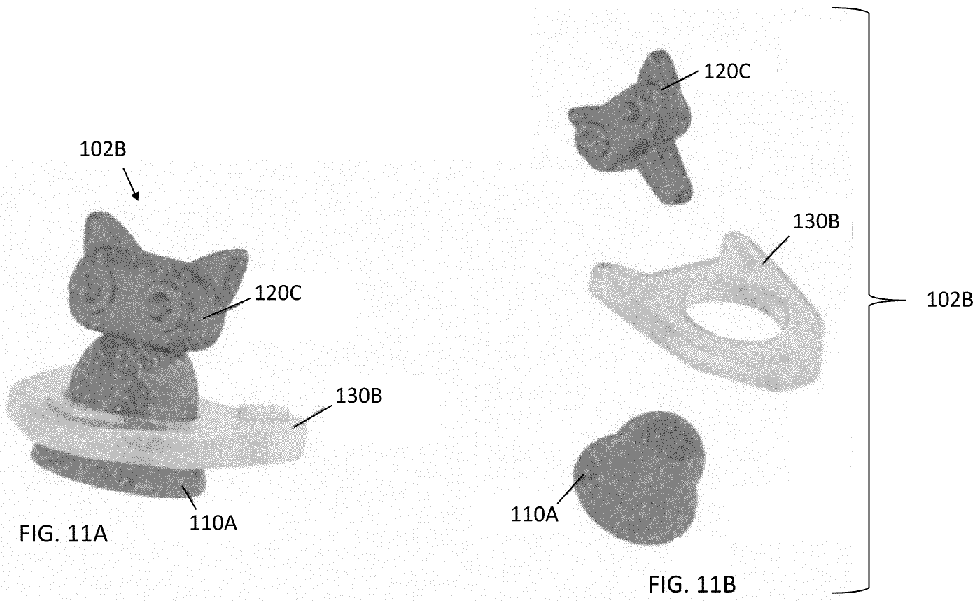

Referring to FIGS. 11A and 11B, a second embodiment of a figure assembly 102B with a particular combination of elements 110, 120 and 130 is shown. The figure assembly 102B is formed from a red first body element 110A, a blue third head element 120C, and a yellow second accessory element 130B.

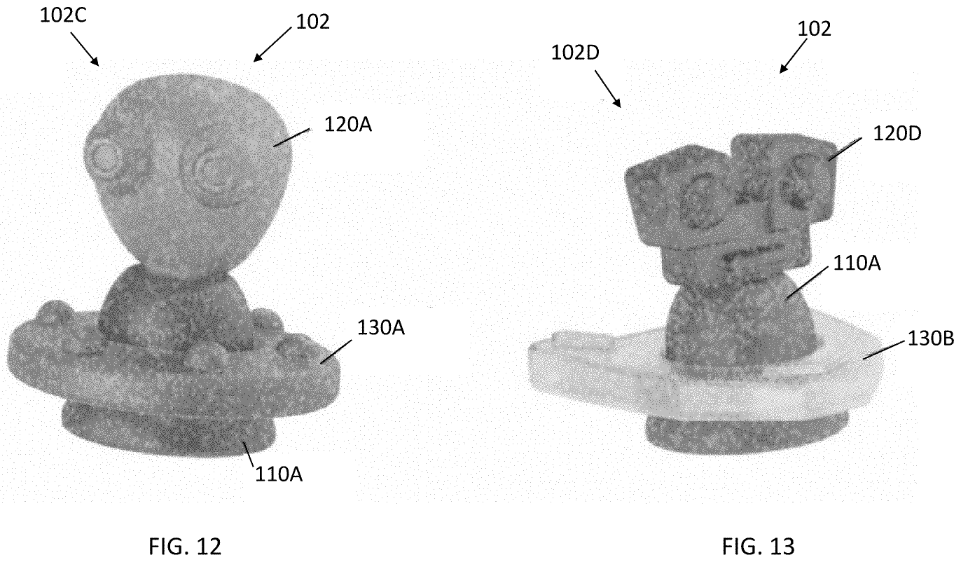

Referring to FIG. 12, a third embodiment of a figure assembly 102C with a particular combination of elements 110, 120 and 130 is shown. The figure assembly 102C is formed from a red first body element 110A, an orange first head element 120A, and a green first accessory element 130A.

Referring to FIG. 13, a fourth embodiment of a figure assembly 102D with a particular combination of elements 110, 120 and 130 is shown. The figure assembly 102D is formed from a red first body element 110A, a fourth third head element 120D, and a yellow second accessory element 130B.

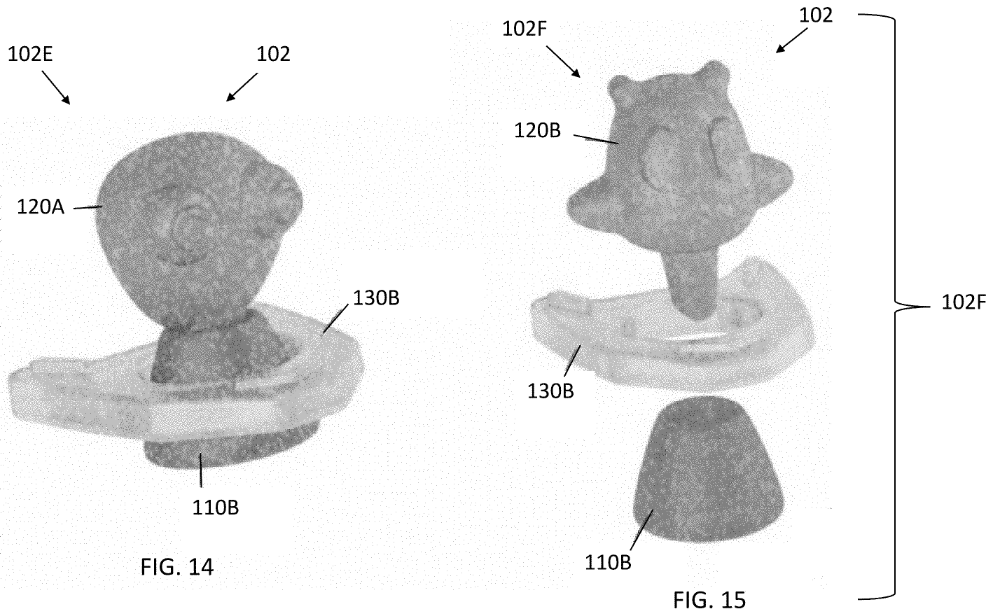

Referring to FIG. 14, a fifth embodiment of a figure assembly 102E with a particular combination of elements 110, 120 and 130 is shown. The figure assembly 102E is formed from a red second body element 110B, an orange first head element 120A, and a yellow second accessory element 130B.

Referring to FIG. 15, a sixth embodiment of a figure assembly 102F with a particular combination of elements 110, 120 and 130 is shown. The figure assembly 102F is formed from a red second body element 110B, an orange second head element 120B, and a yellow second accessory element 130B.

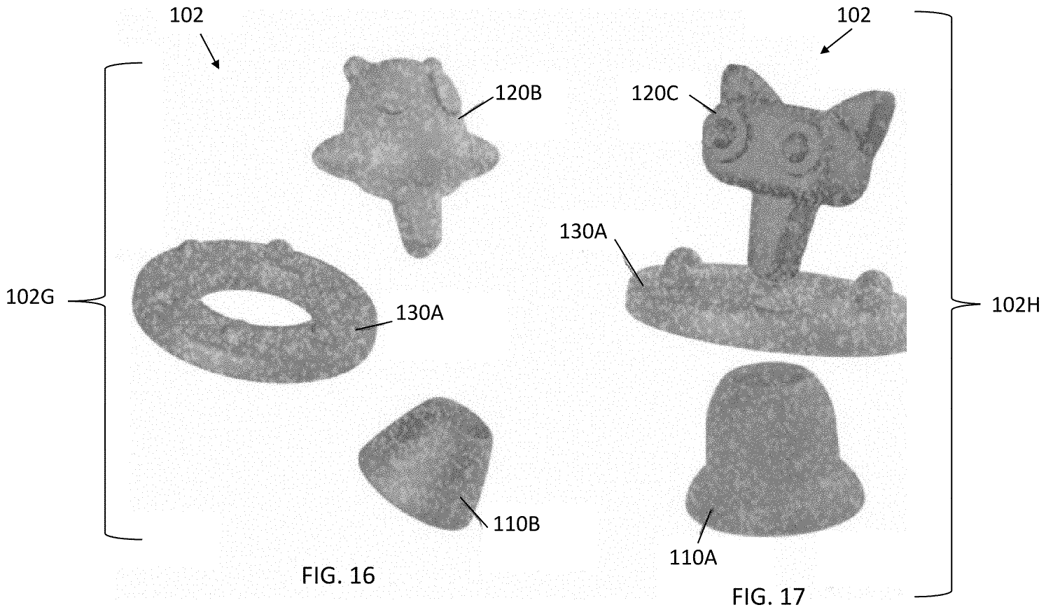

Referring to FIG. 16, a seventh embodiment of a figure assembly 102G with a particular combination of elements 110, 120 and 130 is shown. The figure assembly 102G is formed from a red second body element 110B, an orange second head element 120B, and a green first accessory element 130A.

Referring to FIG. 17, an eighth embodiment of a figure assembly 102H with a particular combination of elements 110, 120 and 130 is shown. The figure assembly 102H is formed from a red first body element 110A, a blue third head element 120C, and a green first accessory element 130A.

Referring to FIGS. 18A-18C, the embodiment of a figure assembly 102C with a particular combination of elements 110, 120 and 130 is shown in black and white line drawing from computer-generated renderings.

Although eight distinct permutations of figures combinations 102A-102H have been shown, the individual elements including bodies 110A, 110B, heads 120A, 120B, 120C, 120D, and accessories 130A and 130B provide for a wide range of possibilities for three-part figure assemblies 102. It can be appreciated that with two (2) body elements, four (4) head elements and two (2) accessory elements, there are 16 distinct three-part figure configurations possible. Sixteen different shape combinations (2×4×2=16) are therefore possible with the aspects shown. Moreover, with the six (6) colors shown: orange, green, red, blue, purple, and yellow, there are ninety-six (96) distinct shape and color configurations possible. However, additional shapes and/or colors could increase the number of permutations and achieve further shape, color, and taste combinations. Additional embodiments can also include two-part figure assemblies, or assemblies including four or more parts.

While the present invention has been described with reference to certain aspects, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all aspects falling within the scope of the appended claims.

What is claimed is:

1. A novelty candy assembly comprising:
at least a first interchangeable element and at least a second interchangeable element wherein the second interchangeable element is interchangeably mountable to the first interchangeable element.

2. The novelty candy assembly of claim 1, wherein the first interchangeable element and/or the second interchangeable element is a gummy.

3. The novelty candy assembly of claim 1, further comprising a third interchangeable element.

4. The novelty candy assembly of claim 1, wherein said first interchangeable element is a head and said second interchangeable element is a body.

5. The novelty candy assembly of claim 4, wherein the first interchangeable element further comprises a receiving channel and the second interchangeable element further comprises a peg-like connector.

6. The novelty candy assembly of claim 5, wherein the peg-like connector is sized and configured to extend into the receiving channel.

7. The novelty candy assembly of claim 4, further comprising an accessory mounted to the head and/or body, the accessory being selected from a plurality of different interchangeable accessories.

8. The novelty candy assembly of claim 7, wherein said accessory has a through-hole that extends completely through the accessory.

9. The novelty candy assembly of claim 8, wherein said head and said body are connected within the through-hole in said accessory.

10. The novelty candy assembly of claim 1 wherein the novelty candy assembly is a figure.

11. A method for forming a novelty candy assembly; the method comprising:
assembling a plurality of first interchangeable elements of different colors and/or shapes with a plurality of second interchangeable elements of different colors and/or shapes; wherein
each of the second interchangeable elements is interchangeably mountable to each of the first interchangeable elements.

12. A method for forming a novelty candy assembly according to claim 11, further comprising assembling a plurality of third interchangeable elements of different colors or shapes; with said first interchangeable elements and said second interchangeable elements; wherein
each of the third interchangeable elements is interchangeably mountable to each of the first interchangeable elements and/or the second interchangeable elements.

13. A method for forming a novelty candy assembly according to claim 12, wherein said first interchangeable element is a head and said second interchangeable element is a body.

14. A method for forming a novelty candy assembly according to claim 13, wherein the third interchangeable elements comprise accessories.

15. A method for forming a novelty candy assembly according to claim 11, wherein the first interchangeable element and/or the second interchangeable element is a gummy.

16. A method for forming a novelty candy assembly according to claim 13, wherein the first interchangeable element further comprises a receiving channel and the second interchangeable element further comprises a peg-like connector.

17. A method for forming a novelty candy assembly according to claim 16, wherein the peg-like connector is sized and configured to extend into the receiving channel.

18. A method for forming a novelty candy assembly according to claim 14, wherein said accessory has a through-hole that extends completely through the accessory.

19. A method for forming a novelty candy assembly according to claim 18, wherein said head and said body are connected within the through-hole in said accessory.

20. A method for forming a novelty candy assembly according to claim 11, wherein the novelty candy assembly is a figure.
